(19) United States
(12) Patent Application Publication
(10) Pub. No.: US 2013/0294791 A1
(43) Pub. Date: Nov. 7, 2013

(54) IMAGE FORMING APPARATUS AND METHOD CAPABLE OF REDUCING DENSITY IRREGULARITY IN TONER IMAGES

(71) Applicant: Keigo NAKAMURA, Kanagawa (JP)

(72) Inventor: Keigo NAKAMURA, Kanagawa (JP)

(21) Appl. No.: 13/871,115

(22) Filed: Apr. 26, 2013

(30) Foreign Application Priority Data
May 1, 2012 (JP) 2012-104860
Feb. 12, 2013 (JP) 2013-024673

(51) Int. Cl. G03G 15/16

(52) U.S. Cl. CPC G03G 15/167
USPC 399/66

(57) ABSTRACT

An image forming apparatus includes an image bearer to bear a latent image formed thereon, a developing device to render visible the latent image borne on the image bearer as a toner image, and a transfer device to transfer the toner image onto a recording medium either directly or via an intermediate transfer member. A granularity detector is provided to detect granularity of the toner image transferred onto the recording medium. A controller is provided to control a transfer rate of toner in the toner image transferred onto the recording medium to reduce the image degradation when the granularity detected by the granularity detector exceeds a prescribed threshold.

### CROSS-REFERENCE TO RELATED APPLICATIONS

This patent application is based on and claims priority pursuant to 35 U.S.C. §119 to Japanese Patent Application Nos. 2012-104860 and 2013-024673, filed on May 1, 2012 and Feb. 12, 2013, respectively, in the Japan Patent Office, the entire disclosures of which are hereby incorporated by reference herein.

### BACKGROUND

1. Technical Field

The present invention relates to an image forming apparatus, such as a copier, a printer, a facsimile, a plotter, or a multifunctional machine including at least one of these capabilities.

2. Related Art

A variety of at least is conventionally used to bear a toner image in an image forming apparatus that employs an electrophotographic imaging system, such as a printer, a copier, etc. When roughly categorized, these include a coated sheet, such as a cast-coated sheet, an art sheet, etc.; an uncoated sheet, such as a high quality sheet, a medium-quality sheet, a low grade sheet, etc.; and a low-grade sheet called an office automation sheet (e.g. plain paper) or the like. However, when a wide image is formed on each of these sheets, density irregularity (e.g., rough skin) can be a problem. Density irregularity is a phenomenon in which in which the toner that constitutes the images does not attached to the recording medium with a uniform density, giving the image a grainy look. Although not prominent in texts or line images, density irregularity is a particular problem with color graphics and images, such as photographs and drawings.

Typically, as taught, for example, in Japan Patent Application Publication No. 2006-091322 (JP-2006-091322-A), each of a quantity of developer borne on a surface of a developing roller, a development gap in a development region, and an apparent density of developer are set to prescribed levels so that a value calculated therefrom can fall within a predetermined range to obtain an appropriate development gap and density of the developer in the developing region in order to prevent the density irregularity.

Further, as taught in Japan Patent Application Publication No. 2004-109325 (JP-2004-109325-A), by uniformly lubricating the surface of an intermediate transfer member, generation of an abnormal image, such as a rough image, etc., can be prevented. However, since the roughness of the sheet surface is a factor that is neglected in JP-2006-091322-A and JP-2004-109325-A, toner transfer incomplete and density irregularity likely occurs with rough or coarse media.

Conventionally, the amount of toner to be used is determined by the surface roughness of the most commonly used type of recording media. In this situation, when a recording sheet with a surface roughness different from the standard recording sheet is used, density irregularity likely occurs.

There are conventional image forming apparatus, in which forming conditions corresponding to multiple types of sheets each having different surface roughness are stored in a memory beforehand to enable the image forming conditions to be changed depending on the depending on a type of image formation. However, the user is required to choose the image forming conditions, which is inconvenient. Further, a sheet can be wasted if the user chooses the wrong image forming conditions. In addition, when an image is formed on a sheet, for which no image forming conditions is stored in the memory in the above-described type of the image forming apparatus, density irregularity likely occurs.

Other conventional image forming apparatuses include a detector to detect surface roughness of a recording sheet and control an amount of toner of a toner image to be transferred onto the recording sheet based on a detection result thereof to prevent density irregularity as taught in Japan Patent Application Publication Nos. 2007-304492 and 2005-257847 (JP-2007-304492-A and JP-2005-257847-A). Specifically, in JP-2007-304492-A, information concerning the type of a transfer sheet member is acquired and data on surface roughness thereof is subsequently obtained to control an amount of toner to be used such that the amount of toner increases as the surface roughness increases. In JP-2005-257847-A, surface roughness is detected by two or more different sheet detectors, and an amount of toner to be used is appropriately controlled in accordance with the detected surface roughness.

However, as already described in the former image forming apparatus, the image forming apparatus of JP-2007-304492-A cannot accommodate a recording sheet, for which no information is stored in a database. Further, although the amount of toner to be used is controlled both in JP-2007-304492-A and JP-2005-257847-A, the problem of density irregularity cannot be handled satisfactorily simply by increasing an amount of toner adhering to the image bearer as the coarseness of the recording medium increases, because by definition the density irregularity means that the transfer rate varies locally and is particularly low in the recesses in the surface of the recording medium.

### SUMMARY

Accordingly, the present invention provides a novel image forming apparatus that comprises an image bearer to bear a latent image formed thereon, a developing device to render visible the latent image borne on the image bearer into a toner image, and a transfer device to transfer the toner image onto a recording medium either directly or via an intermediate transfer member. A granularity detector is provided to detect granularity of the toner image transferred onto the recording medium. An image detector is provided to recognize image degradation when the granularity detected by the granularity detector exceeds a prescribed threshold. A controller is provided to control a transfer rate of toner in the toner image transferred onto the recording medium to reduce the image degradation.

In another aspect of the present invention, a toner adhering amount detector is provided to detect an amount of toner adhering to either the image bearer or the intermediate transfer member before and after the toner image is transferred onto the recording medium. The granularity detector calculates the transfer rate of the toner transferred onto the recording medium based on the adhering amount of the toner detected by the toner adhering amount detector before and after the toner image is transferred thereonto as a transfer rate calculator.

In yet another aspect of the present invention, a surface characteristics detector is provided to detect surface roughness of the recording medium. The controller controls the transfer rate in accordance with the degree of the surface roughness detected by the surface characteristics detector.

In yet another aspect of the present invention, the controller controls the transfer rate to exceed a transfer rate η1 for the maximum difference dmax [m] in roughness detected by the surface characteristics detector, wherein η1=4.5×10⁵×dmax+86[%].

In yet another aspect of the present invention, the controller controls the transfer rate to exceed a transfer rate η2 for an averaged roughness Ra [m] detected by the surface characteristics detector and averaged thereafter, wherein η2=2.46×10⁶×Ra+88[%].

In yet another aspect of the present invention, the controller controls the transfer rate by controlling adhesion of the toner onto either the image bearer or the intermediate transfer member.

In yet another aspect of the present invention, the controller controls the adhesion of the toner by initially forming a toner image on the image bearer and then removing the toner image therefrom while supplying fresh toner into the developing device as a toner ejection control process.

In yet another aspect of the present invention, a lubricant coating device is provided to coat the surface of the image bearer with lubricant. The transfer rate processor controls the adhesion of the toner by changing a quantity of the lubricant coated onto the image bearer.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is an overview illustrating a printer as an image forming apparatus according to one embodiment of the present invention;

FIG. 2 is a schematic diagram illustrating an exemplary configuration of an image formation unit provided in the printer as an image forming apparatus according to one embodiment of the present invention;

FIG. 3 is a block diagram illustrating a control unit according to one embodiment of the present invention;

FIG. 4 is an overview illustrating a cleaning device that cleans an intermediate transfer belt according to one embodiment of the present invention;

FIG. 5 is a diagram illustrating an exemplary configuration of a surface characteristics detector according to one embodiment of the present invention;

FIG. 6 is a diagram illustrating an exemplary characteristic indicating data on surface roughness per recording sheet obtained by the surface characteristics detector according to one embodiment of the present invention;

FIG. 7 is a diagram illustrating an exemplary configuration of an image reading sensor according to one embodiment of the present invention;

FIG. 8 is a flowchart illustrating a granularity calculation process according to one embodiment of the present invention;

FIG. 9 is a diagram illustrating exemplary experimental characteristics indicating a relation between granularity and a subjective evaluation rank of density irregularity according to one embodiment of the present invention;

FIG. 10 is a diagram illustrating an experimental characteristic indicating a relation between an impressed voltage and a transfer rate obtained when a solid image is transferred using toner having different adhesion according to one embodiment of the present invention;

FIG. 11 is a diagram illustrating an experimental characteristic indicating a relation between granularity and a transfer rate obtained when a solid image is transferred using toner having different adhesion according to one embodiment of the present invention;

FIG. 12 is a diagram illustrating an experimental characteristic indicating a relation between a transfer rate and granularity obtained when a solid image is transferred onto a recording sheet with different surface characteristics according to one embodiment of the present invention;

FIG. 13 is a diagram illustrating an experimental characteristic indicating a relation between the maximum difference in roughness of a recording sheet having a different surface characteristic and a transfer rate corresponding to a prescribed threshold of granularity according to one embodiment of the present invention;

FIG. 14 is a diagram illustrating an experimental characteristic indicating a relation between an averaged roughness and a transfer rate causing granularity to be a prescribed threshold according to one embodiment of the present invention;

FIG. 15 is a flowchart illustrating exemplary control operation to eliminate the density irregularity according to one embodiment of the present invention;

FIG. 16 is a flowchart illustrating another control operation to eliminate the density irregularity according to one embodiment of the present invention; and

FIG. 17 is a diagram illustrating a granularity detection result obtained at every 100 numbers of recording sheets according to one embodiment of the present invention.

### DETAILED DESCRIPTION

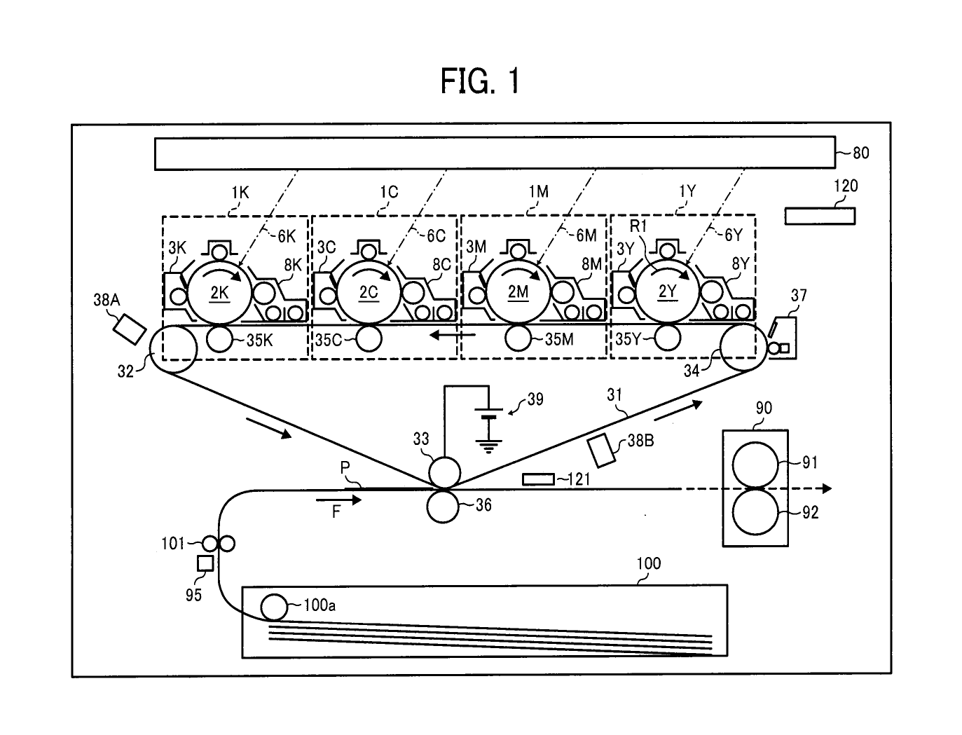

Referring now to the drawings, wherein like reference numerals designate identical or corresponding parts throughout the several views thereof and in particular to FIG. 1, a fundamental configuration of a printer as an image forming apparatus according to one embodiment of the present invention is initially described. As shown there, the printer has four image formation units 1Y, 1M, 1C, and 1K, which form yellow (Y), magenta (M), cyan (C), and black (K) toner images, respectively, a transfer unit 30 as a transfer device, an optical writing unit 80, a fixing device 90, a sheet feeding cassette 100, and a pair of registration rollers 101 or the like.

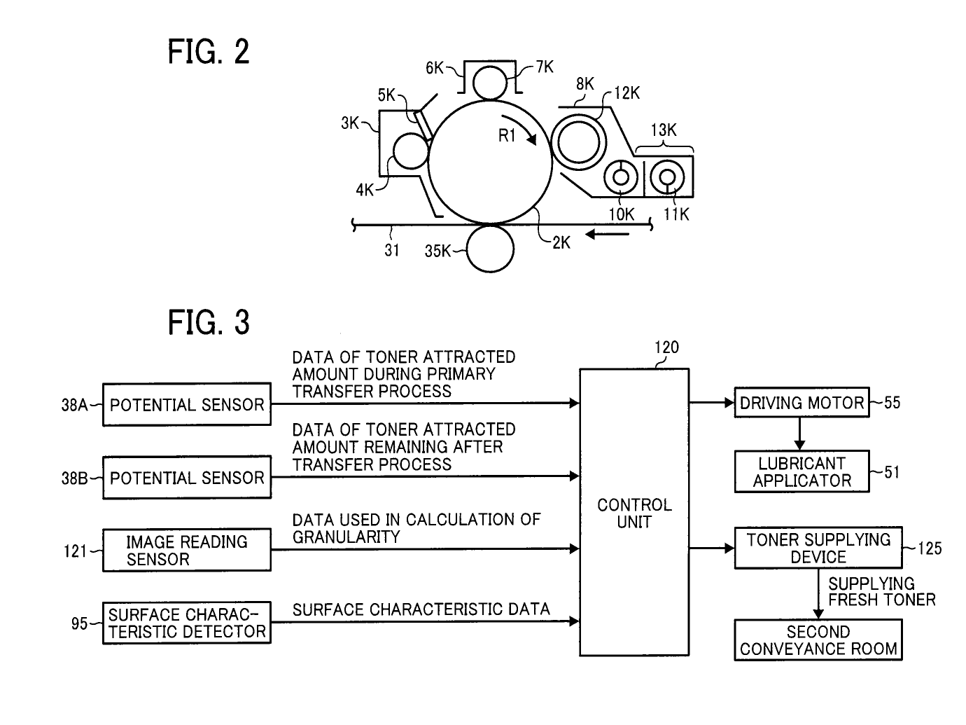

Although these four image formation units 1Y, 1M, 1C, and 1K utilize Y, M, C, and K component color toner particles different from each other as image-forming substance, these have the similar configurations rest of the component color toner and can be replaced upon reaching their lives. Now, the image formation unit 1K which forms a K-component color toner image is typically explained as one example of the present invention with reference to FIG. 2 and applicable drawings. As shown in FIG. 2, a drum-shaped photo-conductor 2K, as an image bearer, a drum cleaning unit 3K, a charge removing device (not shown), a charging device 6K, and a developing device 8K as a developing member are provided. These devices are held by a common holder and are integrally detachably attached to a body of the printer to be replaced simultaneously.

The photoconductor 2K is configured in a drum state including a drum type substrate and an organic light-sensitive layer overlying a surface of the drum substrate with a total diameter of about 60 mm. The photoconductor 2K is driven by a driving device, not shown, clockwise in the drawing. The charging unit 6K causes a charging roller 7K, to which a charging bias is applied, to generate discharge between the charging roller 7K and the photoconductor 2K while either approximating or bringing the charging roller 7K in contact with the photoconductor 2K. Thus, the surface of the photoconductor 2K can be uniformly charged. In this embodiment, the surface of the photoconductor 2K is uniformly charged with a negative polarity equivalent to a normal charging polarity of toner. To employ the charging bias, an AC voltage is superimposed on a DC voltage. The charging roller 7K is constituted by a metal-core coated with a conductive elastic layer made of elastic conductor on a surface thereof. Instead of using a method for bringing the charging component, such as a charging roller, etc., in proximity or in contact with the photoconductor 2K, a not roller type charger system may be employed. Subsequently, the thus electrically uniformly charged surface of the photoconductor 2K is subjected to optical-scanning of laser light emitted from the optical writing unit 80 as described later more in detail and bears an electrostatic latent image of K component color thereon. The K-component color electrostatic latent image is subsequently developed by a developing device 8K, not shown, using K-component color toner to render visible into a K-component color toner image. The K-component color toner image is then primarily transferred onto an intermediate transfer belt 31 as an intermediate transfer member as described later more in detail.

A drum cleaning device 3K removes transfer residual toner adhering to the surface of the photo-conductor 2K after a primary transfer process executed in a later described primary transfer nip. The drum cleaning unit 3K includes a cleaning brush roller 4K driven and rotated by a driver and a cantilever type cleaning blade 5K with its free end contacting the photoconductor 2K. The transfer residual toner 2K is scraped by either the cleaning brush roller 4K when rotated or the cleaning blade and drops from the photoconductor surface.

Here, it is to be noted that, the cleaning blade contacts the photoconductor 2K in a counter direction such that a supporting end of the cantilever is directed downstream of its free end in a drum rotational direction.

The above-described charge removing device removes residual charge remaining on the photoconductor 2K cleaned by the drum cleaning unit 3K. With the thus executed charge removal like this, the surface of the photoconductor 2K is initialized to prepare for the next image formation. The developing device 8K includes a developing roller 12K and a developer conveyance section 13K for agitating and conveying K-component color developer, not illustrated. The developer conveyance section 13K includes a first conveyance chamber that accommodates a first screw 10K and a second conveyance chamber that accommodates a second screw 11K. These screws have rotating shafts with each of those both ends being freely rotatably supported by respective bearings. These screws also include spiral blades protruding in a spiral state from circumferential surfaces of those, respectively. The first and second conveyance chambers respectively housing these screws 10K and 11K in this way are separated by a partition wall 11K. A pair of communicating holes is formed on both ends of the partition wall in an axial direction of the screw 10K or 11K to communicate the both conveyance chambers with each other.

The first screw 10K conveys the K-component color developer, not shown, from a rear side toward a front side (when viewed in a direction perpendicular to a drawing sheet) while stirring the K-component color developer with its rotary driving in a rotating direction. Since the first screw 10K and the developing roller 12K are provided in parallel to face each other, the conveyance direction for the K-component color developer at this time corresponds to a direction of the rotation axis of the developing roller 12K. The first screw 10K supplies the K-component color developer along its axial direction onto a surface of the developing roller 12K. The K-component color developer conveyed near the front end of the first screw 10K in the drawing passes through the communication hole provided near the front end of the partition wall in the draw and enters the second conveyance chamber. The K-component color developer 2 is then conveyed toward the rear side from the front side in the drawing being mixed in a rotational direction as the second screw 11K rotates.

A toner density sensor, not shown, is disposed on a bottom wall of a housing in the second conveyance chamber to detect the K-component color toner density of the K-component color developer stored therein. As the K-component color toner density detection sensor, a magnetic permeability sensor is employed. Since magnetic permeability of the K-component color developer including K-component color toner and magnetic carrier has a correlation with density of the K-component color toner, the magnetic permeability sensor accordingly can detect the density thereof. As shown in FIG. 3, in the second conveyance chambers of the developing devices for Y, M, C, and K component colors provided in the printer, toner supply devices 125 are provided to supply Y, M, C, and K toner particles, respectively.

A RAM (i.e., a Random Access Memory) provided in the printer control unit 120 stores reference values “Vtref” for Y, M, C, and K component colors as target values of output voltages outputted from the toner density detection sensors, respectively. If a difference between the output voltage from each toner density detection sensor and each of the Y, M, C, and K use Vtref values exceeds a prescribed level, each toner supply device 125 is driven for a prescribed time period in accordance with the difference. Thus, in the second conveyance chambers of the developing devices for Y, M, C, and K component colors, fresh Y, M, C, and K-component color toner particles are replenished, respectively, upon need. Further, as shown in FIG. 2, the developing roller 12K is opposed to both the first screw 10K and the photoconductor 2K through an opening provided in a housing. The developing roller 12K has a cylindrical developing sleeve mainly composed of a nonmagnetic pipe driven and rotated by a motor, and a magnetic roller fixed inside the sleeve not to be driven and rotated. The developing roller 12K bears the K-component color developer supplied from the first screw 10K on the surface of the sleeve due to magnetic force generated by a magnet roller, and conveys the K-component color developer to a developing region opposed to the photoconductor 2K as the sleeve rotates.

A developing bias greater than an electric potential of an electrostatic latent image formed on the photoconductor 2K and smaller than that of a uniformly charged electric potential of the photoconductor 2K having the same polarity as the toner is applied to the developing sleeve. Accordingly, development potential operates between the developing sleeve and the electrostatic latent image formed on the photoconductor 2K to shift the K-component color toner borne on the developing sleeve to the electrostatic latent image. Between the developing sleeve and a background of the photoconductor 2K, non-development potential operates to move the K-component color toner on the developing sleeve (background) toward the surface of the developing sleeve. Thus, by the operations of these development potential and non-development potential, the K-component color toner on the developing sleeve is selectively transferred onto the electrostatic latent image formed on the photoconductor 2K and develops the electrostatic latent image into the visible K-component color toner image.

Further, also in the remaining image formation units 1Y, 1M, and 1C, toner images are similarly formed on the photoconductors 2Y, 2M, and 2C, respectively, as well. Further, as shown in FIG. 1, above the image formation units 1Y, 1M, 1C, and 1K, the optical writing unit 80 is disposed as a latent image writing device. Specifically, the optical writing unit 80 provides optical scanning to the photoconductors 2Y, 2M, 2C, and 2K with laser light emitted from a laser diode based on image information coming from an external device, such as a personal computer, etc. With such optical scanning, electrostatic latent images for Y, M, C, and K are accordingly formed on the photoconductors 2Y, 2M, 2C, and 2K, respectively. Specifically, among the entire region of the uniformly charged surface of the photo-conductor 2, a region exposed to the laser light causes electrical potential decay. Hence, the laser irradiation region provides an electrostatic latent image having an electrical potential less than that of the other region (i.e., the background). Further, the optical writing unit 80 polarizes a laser light beam L emitted from a light source in a main scanning direction with a polygonal mirror driven and rotated by a polygon motor, not shown, and irradiates the laser light beam L toward the photoconductors via multiple optical lenses and mirrors. In such a situation, a system that executes optical writing with an LED light emitted from multiple LEDs constituting an LED array can be adopted instead.

Below the image formation units 1Y, 1M, 1C, and 1K, the transfer unit 30 is disposed as described earlier to support and circulate the endless intermediate transfer belt 31 as an image bearer counterclockwise in the drawing. Beside the intermediate transfer belt 31, the transfer unit 30 includes a driving roller 32, a secondary transfer backside roller 33, a cleaning backup roller 34, four primary transfer rollers 35Y, 35M, 35C, and 35K, a nip formation roller 36, a belt cleaning unit 37, and multiple electric electrical potential sensors 38A and 38B or the like.

The intermediate transfer belt 31 is supported by the driving roller 32, the secondary transfer backside roller 33, the cleaning backup roller 34, and the four primary transfer rollers 35Y, 35M, 35C, and 35K each provided inside the loop thereof to be able to circulate. The intermediate transfer belt 31 is endlessly moved by a torque of the driving roller 32 rotated and driven counterclockwise by a driving device, not shown, in the same direction as that of the driving roller 32. The intermediate transfer belt 31 employed here has the below described characteristics. Specifically, a thickness of the intermediate transfer belt 31 is preferably from about 20 μm to about 200 μm, and is more preferably about 60 μm. A volume resistivity of the intermediate transfer belt 31 is preferably from about the product of 1×10⁶ Ωcm to about that of 1×10¹² Ωcm, and is more preferably about the product of 1×10⁹ Ωcm.

The volume resistivity is measured by a resistivity measuring instrument (MCP HT45 Model) manufactured by Mitsubishi Chemical when 100V is applied to the intermediate transfer belt 31.

The four primary transfer rollers 35Y, 35M, 35C, and 35K hold the endlessly moving intermediate transfer belt 31 incorporation with the photoconductors 2Y, 2M, 2C, and 2K. With this, multiple primary transfer nips for Y, M, C, and K component colors are formed, in which a front surface of the intermediate transfer belt 31 engages with the photoconductors 2Y, 2M, 2C, and 2K. To each of these four primary transfer rollers 35Y, 35M, 35C, and 35K, a primary transfer bias is applied by a transfer bias power supply, not shown. Hence, transfer electric fields are formed between Y, M, C, and K-component color toner images borne on the photoconductors 2Y, 2M, 2C, and 2K and the primary transfer rollers 35Y, 35M, 35C, and 35K, respectively. Thus, the Y toner image formed on the surface of the photoconductor 2Y enters the primary transfer nip for the Y component color as the photo-conductor 2Y rotates. Subsequently, the Y toner image is primarily-transferred from the photo-conductor 2Y onto the intermediate transfer belt 31 by the operation of the transfer electric field under a nip pressure. The intermediate transfer belt 31Y with the primary transferred toner image successively traverses the primary transfer nips for the M, C, and K component colors sequentially. Further, the M, C, and K-component color toner images on the respective photoconductors 2M, 2C, and 2K are successively superimposed on the Y toner image as the primary transferring. Hence, with such superposition during the primary transferring, a four component color superimposed toner image is formed on the intermediate transfer belt 31.

Each of the primary transfer rollers 35Y, 35M, 35C, and 35K is composed of an elastic roller having a metal core and a conductive sponge layer fixed onto a surface of the metal core and has the below described characteristics. An outer diameter of the primary transfer roller is about 16 [mm]. An outer diameter of the primary transfer roller is about 16 [mm]. A diameter of the metal core is about 10 [mm] A resistance R of the sponge layer is about the product of 3×10⁷(Ω) as calculated by Ohm's law (R=V/I) based on a current I, which flows when a grounded metal roller with an outer diameter of about 30 mm is pressed against the sponge layer under the force of 10[N] while 1000 voltage is applied to the metal core of the primary transcript roller. To each of such primary transfer rollers 35Y, 35M, 35C, and 35K, the primary transfer bias is applied under constant current control. Here, instead of the primary transfer rollers 35Y, 35M, 35C, and 35K, transfer chargers or brushes may be employed as well.

Since the nip forming roller 36 of the transfer unit 30 is disposed outside the loop of the intermediate transfer belt 31, the intermediate transfer belt 31 is sandwiched between the nip forming roller 36 and a secondary transfer backside roller 33 disposed inside the loop thereof. Hence, a secondary transfer nip is formed so that a front side surface of the intermediate transfer belt 31 engages with the nip forming roller 36 therein. The nip forming roller 36 is grounded. By contrast, the secondary transfer backside roller 33 is provided with the secondary transfer bias from a secondary transfer bias power supply 39. Hence, between the secondary transfer backside roller 33 and the nip forming roller 36, a secondary transfer electric field is formed to electrostatically move toner having a negative polarity from the secondary transfer backside roller 33 toward the nip forming roller 36.

Below the transfer unit 30, a sheet feeding cassette 100 is disposed to accommodate a bunch of recording sheets, i.e., a stack of multiple recording sheets P as recording media. In the sheet feeding cassette 100, a sheet feeding roller 100a contacts the top of the bunch of recording sheets P, and sends the topmost recording sheet P toward a sheet feeding path when driven and rotated at a predetermined time. Near the end of the sheet feeding path, a pair of registration rollers 101 is provided. The pair of registration rollers 101 stops its rotation immediately when pinching the recording sheet P sent from the sheet feeding cassette 100 therebetween. The pair of registration rollers 101 resumes its rotation and sends the recording sheet P sandwiched therebetween toward the secondary transfer nip at a prescribed time synchronizing with the four component color superimposed toner image borne on the intermediate transfer belt 31 in the secondary transfer nip.

The four component color superimposed toner image tightly contacts the recording sheet P on the intermediate transfer belt in the secondary transfer nip and is secondarily transferred thereonto at once in the secondary transfer electric field under the nip pressure. Thus, the four component color superimposed toner image becomes a full-color toner image contrasting with a white background of the recording sheet P. The recording sheet P bearing the thus formed four component color toner image on its surface then separates from the intermediate transfer belt 31 and the nip forming roller 36 due to its curvature after passing through the secondary transfer nip. Further, the secondary transfer backside roller 33 has the below described characteristics. An outer diameter of the secondary transfer backside roller 33 is approximately 24 [mm]. A diameter of the metal core is approximately 16 [mm]. A surface of the metal core is coated with an electrically conductive NBR rubber layer. A resistance R of the electrically conductive NBR (Nitrile Butadiene Rubber) layer is preferably from about the product of 1×10⁶[Ω] to that of about 1×10¹²Ω, and is more preferably the product of about 4×10⁷[Ω]. The resistance R is the value measured by the same manner as that of the primary transfer roller.

The nip forming roller 36 has the below described characteristics. An outer diameter of the nip forming roller 36 is approximately 24 [mm]. A diameter of the metal core of the nip formed roller 3 is approximately 14 [mm]. A surface of the metal core is coated with an electrically conductive NBR rubber layer. A resistance R of the electrically conductive NBR rubber layer is preferably about 1 E 6[Ω] or less. The resistance R is a value measured by the same manner as that of the primary transfer roller. Further, the secondary transfer bias power supply 39 has a DC (Direct Current) power supply and is enabled to output a direct current as a secondary transfer bias. An output terminal of the secondary transfer bias power supply 39 is connected to the metal core of the nip formed roller 36. An electrical potential of the metal core of the nip forming roller 36 is substantially the same as an output voltage outputted from the secondary transfer bias power supply 39. Whereas, a metal core of the secondary transfer backside roller 33 is ground (i.e., earth connection). Instead of grounding the metal core of the nip forming roller 36 while applying the secondary transfer bias to the metal core of the secondary transfer backside roller 33, the metal core of the secondary transfer backside roller 33 can be ground while applying the secondary transfer bias to the metal core of the nip formed roller 36. In such situation, a polarity of the direct current needs to be differentiated.

Some of transfer residual toner not transferred onto the recording sheet P is adhering to the intermediate transfer belt 31 passing through the secondary transfer nip. The transfer residual toner is however cleaned by a belt cleaning unit 37 engaging with the front surface of the intermediate transfer belt 31. A cleaning backup roller 34 also disposed inside the loop of the intermediate transfer belt 31 to back up the belt cleaning unit 37 to clean the intermediate transfer belt 31 from inside the loop thereof.

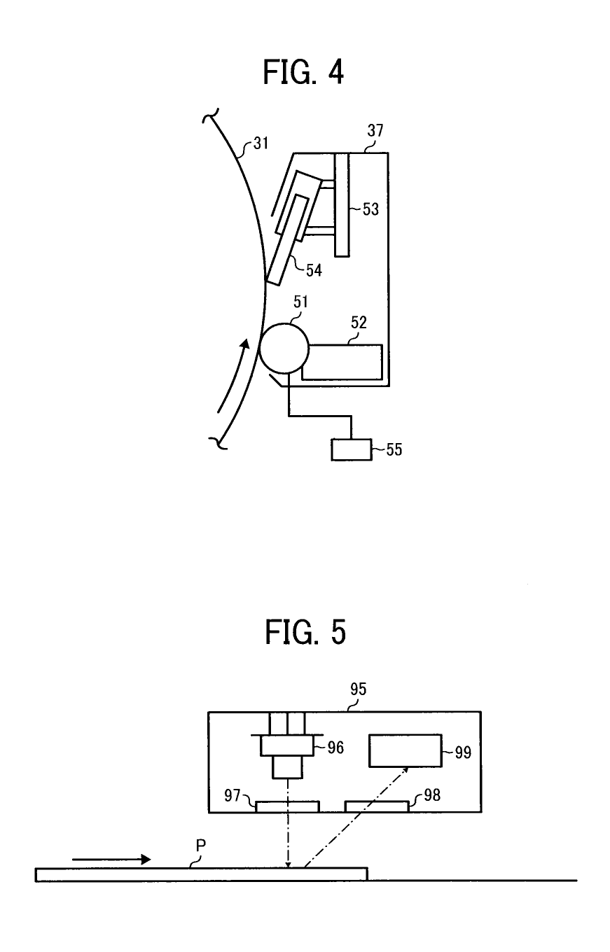

Now, an exemplary interior configuration of the cleaning unit 37 is described with reference to FIG. 4. The intermediate transfer belt 31 is circulating in a direction as shown by arrow in FIG. 4. Thus, residual toner on the intermediate transfer belt 31 is removed by the cleaning blade 54 from the front surface of the intermediate transfer belt 31. The cleaning blade 54 is made of an elastic member, such as polyurethane rubber, etc. In a housing of the cleaning unit 37, a lubricant coating device with a lubricant coating member 51, a solid lubricant 52, and a driving motor 55 are installed. The lubricant coating member 51 is formed from a metal roller and a base cloth winding around the base cloth. The base cloth includes multiple brush hairs, a length of which is from about 4 mm to about 5 mm, made of, for example, nylon or polyester and the like planted thereon. An invasion amount of each of the intermediate transfer belt 31 and the solid lubricants 52 invading into the brush hair is about 1 mm. Thus, by rotating the lubricant coating member 51, the solid lubricant 52 is pulverized and scraped off to be applied to the front surface of the intermediate transfer member 31. Further, a driving motor 55 is connected to the cleaning unit 37 to rotate the lubricant coating member 51. A rotational speed and a rotational direction of the drive motor 55 can be changed. When the rotational direction is switched, a contacting direction of the intermediate transfer belt 31 changes regarding the brush 51. As a result, the brush hair of the brush 51 can be prevented from falling down decreasing a quantity of the lubricant to be applied. Further, since the quantity of lubricant can be generally controlled by changing the rotational speed, the quantity of the lubricant can be optionally controlled upon need. Specifically, the lubricant application control is one of improving manners improving the transfer rate.

As shown in FIG. 1, an electrical potential sensor 38A as a toner adhering amount detector is disposed outside the loop of the intermediate transfer belt 31. Specifically, among the entire region in a circumferential direction of the intermediate transfer belt 31, the electrical potential sensor 38A is disposed facing the intermediate transfer belt 31 at a winding point thereof, in which the drive roller 32 grounded is wound, via a gap of about 4 [mm]. The electrical potential sensor 38A measures an amount of a toner image primary transferred onto the intermediate transfer belt 31 when the toner image enters an opposed position thereto. Similar to the electrical potential sensor 38A, an electrical potential sensor 38B as a toner adhering amount detector is also disposed outside the loop of the intermediate transfer belt 31. Specifically, at a downstream position of the secondary transfer backside roller 33 in a belt moving direction, the electrical potential sensor 38B faces the front surface of the intermediate transfer belt via a gap about 4 [mm]. The electrical potential sensor 38B also measures a toner adhering amount when residual toner image not transferred onto a transfer sheet P at the secondary transfer section enters an opposed position thereto.

On the right side of the secondary transfer nip in the drawing, a fixing device 90 is provided. The fixing device 90 includes a fixing roller 91 containing a heat source, such as a halogen lamp, etc., and a pressing roller 92 which rotates contacting the fixing roller 91 under a predetermined amount of pressure thereby forming a fixing nip therebetween. Thus, the recording sheet P sent to the fixing device 90 is pinched in the fixing nip with its surface carrying an unfixed toner image tightly adhering to the fixing roller 91. Subsequently, toner in the toner image is softened under influence of heat or pressure so that the full-color image is fixed. The recording sheet P is then ejected from the fixing device 90 and is discharged to an outside of the image forming apparatus after passing through a post fixing process conveyance path.

When a black and white (i.e., a monochromatic) image is formed, a support plate, not shown, that supports the multiple primary transfer rollers 35Y, 35M, and 35C for Y, M, and C component colors provided in the transfer unit 30Y, 30M, 30C, respectively, is moved, to depart these primary transfer rollers 35Y, 35M, and 35C from the photoconductors 2Y, 2M, and 2C, respectively. Hence, the front surface of the intermediate transfer belt 31 is separated from the photoconductors 2Y, 2M, and 2C, while only contacting the photoconductor 2K for K component color. In this situation, a K-component color toner image is formed on the photo-conductor 2K by only driving the image formation unit 1K for K-component color among the four image formation units 1Y, 1M, 1C, and 1K.

Now, toner ejection control according to one embodiment of the present invention is described. Specifically, the toner ejection control is executed by the below described method as one of methods of controlling toner adhesion. That is, to implement the method, a laser light beam is emitted to the photoconductor 2 from the optical writing unit 80 so that the photoconductor 2 is entirely exposed thereby forming an electrostatic latent image thereon. The electrostatic latent image thus formed is subsequently rendered visible by the developing device 8 into a toner image while consuming toner. Subsequently, the toner image is removed from the photoconductor 2 by the drum cleaning unit 3 while supplying fresh toner to the developing device 8.

Now, a method of detecting surface roughness of a recording sheet P is described with reference to FIG. 1 and applicable drawings. As shown in FIG. 1, there is provided a surface characteristics detector 95 to detect surface roughness (i.e., a surface characteristic) of the recording sheet P in the middle of the conveyance path extending from the sheet feeding roller 100a accommodated in the sheet feeding cassette 100 to the intermediate transfer belt 31. The surface characteristics detector 95 reads a surface of the recording sheet P fed by the sheet feeding roller 100a from the sheet feeding cassette 100 and detects surface characteristics thereof based on an image of the read surface. Data on the surface characteristics of the recording sheet detected by the surface characteristics detector 95 are outputted to the control unit 120. Surface irregularity information is then detected by the control unit 120, and the maximum difference in roughness dmax and an averaged roughness Ra are calculated based on the thus detected surface characteristics. Here, the control unit 120 and the surface characteristics detector 95 collectively constitute a granularity detector.

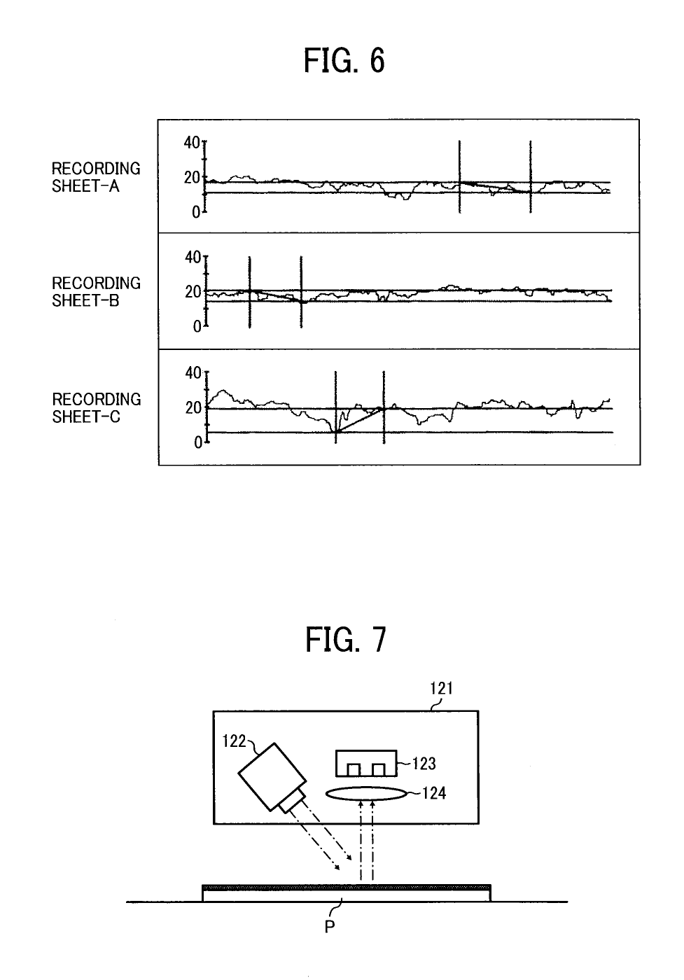

Now, an exemplary configuration of a laser displacement meter is described as one example of the surface characteristics detector 95 with reference to FIG. 5. The surface characteristics detector 95 has a semiconductor laser 96 as a light source. A coherent light beam emitted from the semiconductor laser 96 is focused after passing through a transmitter lens 97 and is irradiated to a designated area on the recording sheet P. A part of a light beam diffused and reflected from the recording sheet P forms a spot on an optical position detector 99 after passing through a light receiver lens 98. Accordingly, by detecting a position of the spot, surface roughness on the recording sheet P can be detected. FIG. 6 is a diagram schematically illustrating a surface roughness outputted by the surface characteristics detector 95. Respective recording sheets A, B, and C shown in FIG. 6 have different sheet smoothness from each other. Specifically, the recording sheet A has the most preferable smoothness while the recording sheet C has the worst smoothness. Based on this detection result, the maximum difference in roughness and an averaged roughness of each recording sheet can be sought as shown in the below described first Table.

FIRST TABLE

| | Dmax (μm) | Ra (μm) |
|---|---|---|
| Recording sheet A | 9.0 | 0.88 |
| Recording sheet B | 13.0 | 1.30 |
| Recording sheet C | 16.5 | 2.31 |

Now, a method of calculating a transfer rate of toner transferred onto a recording sheet P is described. To calculate the transfer rate, detection data obtained by multiple electrical potential sensors 38A and 38 B are utilized. Specifically, the electrical potential sensor 38A measures an adhering amount Tb [g] of a toner image primarily transferred onto the intermediate transfer member 31. After (the secondary) transfer, the electrical potential sensor 38B measures residual toner adhering amount Tr [g] at the same position (of the intermediate transfer member) detected by the electrical potential sensor 38A. Then, the transfer rate is calculated from the detection result based on a definition of the transfer rate as calculated by the expression (1−Tr/Tb)×100[%]. Specifically, these detection data pieces obtained (generated) by the electrical potential sensors 38A and 38 B are outputted to the control unit 120 as a transfer rate calculator. The control unit 120 subsequently calculates the transfer rate based on the detection data.

Now, an exemplary method of determining a granularity implemented in this embodiment is described with reference to FIG. 7 and applicable drawings. To measure the granularity, an image reading sensor 121 placed downstream of the secondary transfer backside roller 33 in the recording sheet conveyance direction is used as shown in FIG. 1. An exemplary configuration of the image reading sensor 121 is now described with reference to FIG. 7. The image reading sensor 121 includes a reflection type LED (Light Emitting Device) 122 as an exposure device, a line sensor 123 as a reading device, and an imaging lens 124. A light beam emitted from the reflection type LED is directed toward a toner image on a recording sheet P. A light beam reflected from the toner image is collimated and focused on the line sensor 123 through the imaging lens 124. An image of a desired region is formed by storing solid image pattern data on cyan, magenta, yellow, and black component colors in a memory to make it readable for the image reading sensor. In this embodiment, the reading sensor 121 takes a photograph of a toner image transferred from a solid image onto the recording sheet P in the secondary transfer section and a granularity thereof is calculated.

The granularity is represented by the below described third expression. However, this embodiment is just one example, and another expression that represents a degree of granularity can be utilized, because a prescribed threshold of the granularity simply changes without newly raising a problem in executing other controlling. Granularity=exp(aL+b)∫{WS(f)̂(½)}×VTF(f)df+c∫{WS_{c1}(f) [symbol] (½)}×VTF_{c1}(f)df+d∫{WS_{c2}(f) [symbol] (½)}×VTF_{c2}(f)df . . . (Third expression), wherein “L” represents an averaged lightness, “f” represents a spatial frequency (c/mm), “WS(f)” represents a power spectrum of a change in lightness, “WS_{c1}(f)” and “WS_{c2}(f)” represent power spectrums of changes in colorimetric, “VTF(f)” represents visual spatial frequency characteristics of a lightness component, “VTF_{c1}(f)” and “VTF_{c2}(f)” represent visual spatial frequency characteristics of a colorimetric component, and “a”, “b”, “c”, and “d” represent coefficients, respectively.

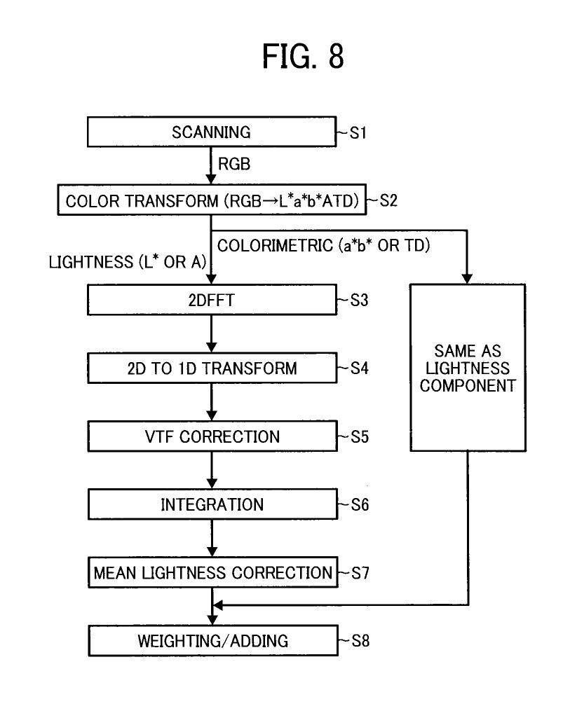

Specifically, the above-described expression is obtained by seeking values of the lightness and colorimetric components respectively, and a linear sum calculation is made based thereon. These coefficients “a” to “d” serve as weightings which represent contributions to the granularity of the respective components (i.e., two colorimetric levels and a lightness). Now, a sequence of calculating the granularity is described with reference to FIG. 8. As shown there, a color conversion process for seeking lightness and colorimetric components based on a photographed image is initially executed (in steps from S2 to S4). Then, variations in the lightness and colorimetric components weighted in accordance with the spatial frequency are integrated respectively, thereby obtaining granularities of the lightness and colorimetric components (in steps S5 and S6). Subsequently, a function having an averaged lightness as a variable and the granularity of the lightness component are multiplied in step S7. Subsequently, a linear sum calculation is made based on the thus obtained product and that of the colorimetric component in step S8, thereby calculating the granularity as described more in detail in JP-2006-091322-A.

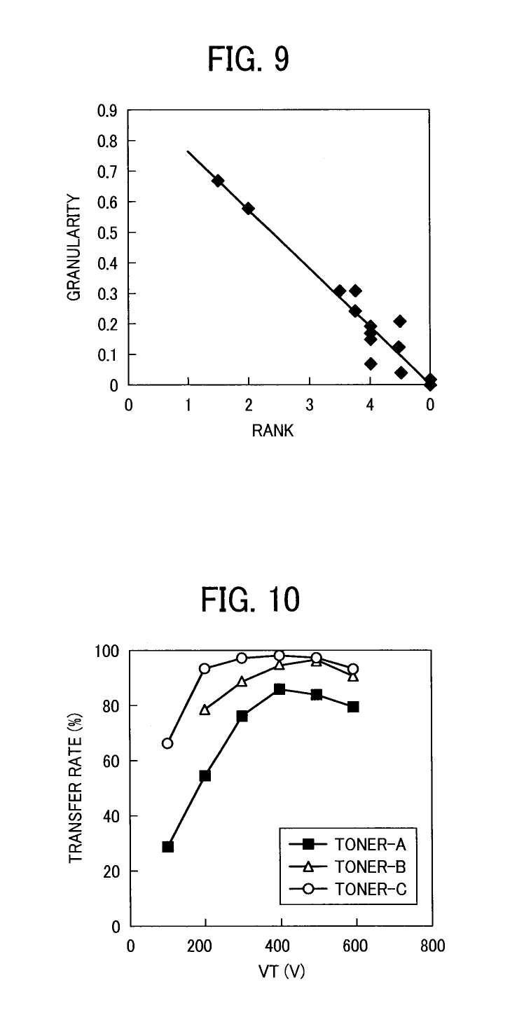

Now, a reason why density irregularity can be represented by the above-described granularity is described with reference to FIG. 9 and applicable drawings. As shown in FIG. 9, a relation between the above-described granularity and density irregularity obtained when a solid image is printed onto recording sheets A and C is illustrated. As also shown there, the density irregularity is subjectively evaluated in five stages (i.e., first to fifth ranks). In the subjective evaluation in this embodiment, an output image is visually evaluated and is graded on five steps (i.e., ranks) as described below. Specifically, the fifth rank is given if the density irregularity does not occur at all. The fourth rank is given if image quality is not bad while the density irregularity slightly occurs. The third rank is given if the density irregularity slightly occurs by some degree while an image is not apparently regarded as being degraded. The second rank is given if the density irregularity occurs at several locations having poor image quality. The first rank is given if image quality degradation occurs due to the density irregularity.

Further, as shown in FIG. 9, a preferable correlation is obtained between the granularity and the subjective evaluation result. Thus, it can be understood that the density irregularity can be determined in accordance with the granularity. Therefore, by controlling the granularity below a certain value, a fine quality image can be frequently obtained while almost avoiding the density irregularity. In other words, there is a prescribed threshold in the granularity not generating the density irregularity. Specifically, by detecting the granularity in real time and recognizing its deviation from the prescribed threshold thereby determining the density irregularity, a fine image can be frequently obtained. Further, since the granularity and the above-described rank can be plotted on the same correlation curve even if a recording sheet is different, the granularity determining the density irregularity is unaffected by the difference in type of the recording sheet.

Now, a reason for controlling the transfer rate as a counter measure capable of resolving a problem of the density irregularity is described with reference to FIG. 10 and applicable drawings. In FIG. 10, a relation between an applied voltage and a transfer rate obtained when a solid image is transferred onto the recording sheet A using three types of toner adhering thereto having a different adhesion from each other is illustrated. Further, the second Table illustrates adhesion of toner used. Such toner adhesion is measured using a centrifugal separation method as described in Japanese Patent No. JP-3670134-B2 (JP-H11-258081-A).

| | SECOND TABLE |
|---|---|
| | Adhesion (nN) |
| Toner A | 390 |
| Toner B | 173 |
| Toner C | 62 |

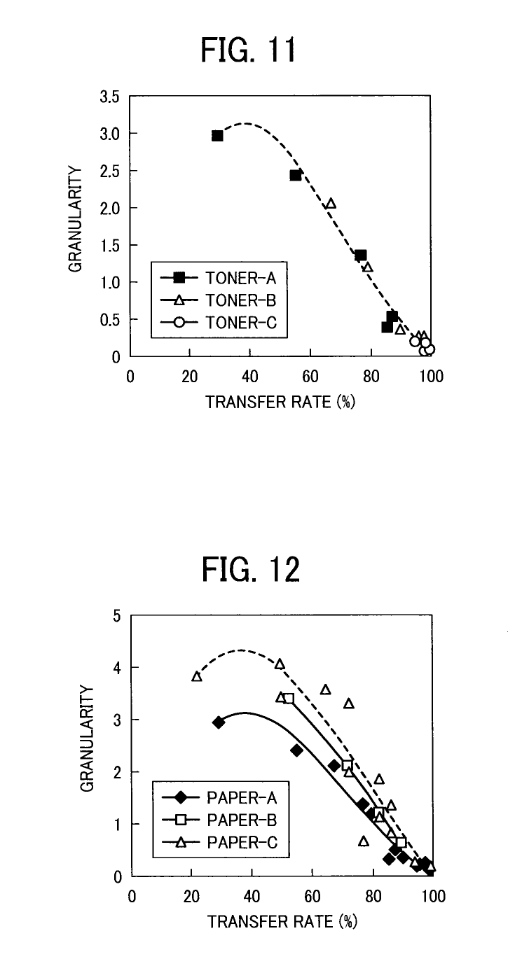

As apparently understood from FIG. 10, the transfer rate varies in accordance with the adhesion even under the same applied voltage. Specifically, the transfer rate increases as the adhesion decreases. Thus, it can be understood that the transfer rate can be controlled by changing the adhesion. Further, in FIG. 11, a relation between the transfer rate and the granularity obtained when the solid image is transferred onto the recording sheet A using toner particles A, B, and C is illustrated. As shown there, since the transfer rate and the granularity have a prescribed mutual relation regardless of the adhesion, it is understood that the transfer rate simply needs to be improved to suppress the granularity below a certain value (a prescribed value). That is, it is also understood that as a specific method of controlling the granularity, it is effective to control the transfer rate of the toner image transferred onto the recording sheet P. Further, by detecting the transfer rate when an image is formed using a transfer rate detector composed of the above-described electrical potential sensors 38A and 38B and the control unit 120 and controlling the transfer rate to exceed the prescribed threshold all the time, a fine quality image can be frequently obtained.

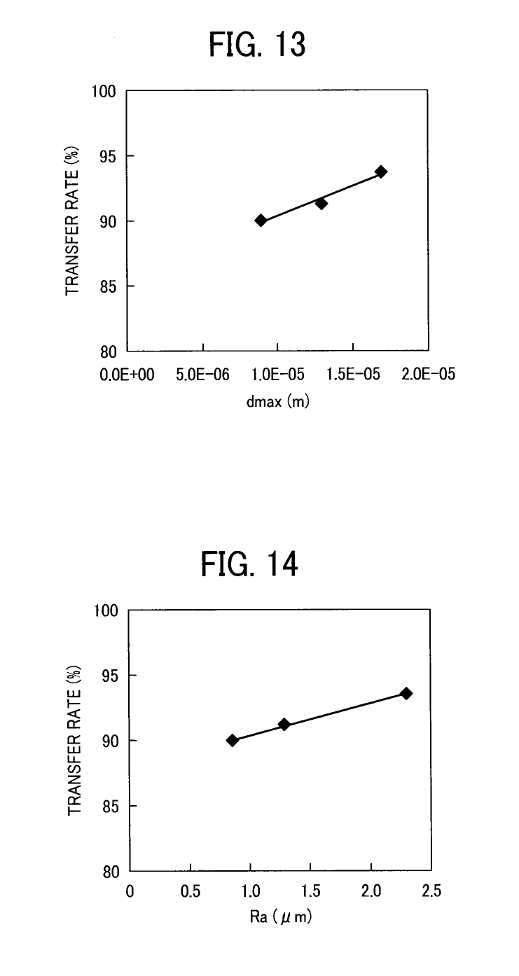

Now, with reference to FIG. 12, a relation between the transfer rate and the granularity obtained when the solid image is transferred onto each of the recording paper sheets A, B, and C is described. As there shown, it is understood that a mutual relation curve is different per recording (paper) sheet. That is, the larger the surface roughness, the higher threshold of the transfer rate causing the density irregularity. Accordingly, since a transfer rate required to obtain an image without density irregularity depends on the recording paper sheet, a fine quality image can be obtained if the transfer rate is appropriately controlled in accordance with the recording (paper) sheet. In this embodiment, the prescribed threshold of granularity is about 0.4, which corresponds to the third rank of the subjective evaluation as shown in FIG. 9. Now, a relation between the transfer rate corresponding to the granularity of about 0.4 and the maximum difference in roughness in each of the recording paper sheets A, B, and C is described with reference to FIG. 13. As shown there, the granularity and the transfer rate are substantially proportional to the surface irregularities in the recording paper sheets, and accordingly can be represented by the below described second expression; η1=4.5×10⁵×dmax+86 (First expression), wherein “η1” represents a transfer rate [%], and “dmax” represents the maximum difference [m] in unevenness in a recording paper sheet. Thus, a fine quality image can be obtained without the density irregularity by increasing the transfer rate greater than the threshold in relation to the surface roughness of the recording paper sheet as sought by the above-described second expression. In other words, if toner is transferred keeping the high transfer rate for a recording sheet having a great surface unevenness to exceed the threshold of the transfer rate, a stable image can be frequently obtained regardless of the recording paper sheet while almost avoiding the density irregularity.

FIG. 14 illustrates a relation between the averaged roughness Ra and the transfer rate causing the granularity to be about 0.4. As shown there, the averaged roughness Ra and the transfer rate have a mutual relation again and can be represented by the below described third expression; η2=2.46×10⁶×Ra+88 (Second expression), wherein “η2” represents the transfer rate [%], and “Ra” represents the averaged roughness of a recording paper sheet [m]. Thus, a fine quality image can be again obtained without the density irregularity by utilizing the averaged roughness of the recording paper sheet. Since this embodiment is just one example, another parameter representing a sheet surface condition, such as an averaged roughness Sa of a recording paper sheet, which is obtained by entirely or partially detecting unevenness of the recording paper sheet and averaging the detection result, etc., can be used.

Now, a method of controlling the transfer rate is described. The density irregularity occurs mainly because the transfer rate locally decreases due to surface roughness of a recording sheet and an uneven electric field caused by the surface roughness thereof. Since a gap is typically created between the recording sheet and the image bearer in accordance with the surface roughness of the recording sheet when toner is transferred from the image bearer onto the recording sheet, an electric field applied to the toner varies depending on a position of the recording sheet. Further, since the electric field is relatively weaker in the particularly large gap section than other positions, a transfer electric field readily becomes insufficient, and toner is not completely transferred thereby causing the density irregularity. When the recording sheet having a large surface roughness is used, since the gap between the recording sheet and the image bearer is wide, and accordingly the electric field is significantly uneven, the density irregularity highly likely occurs. Whereas when a recording sheet having a small surface roughness is used, since the gap between the recording sheet and the image bearer is relatively small, and accordingly the electric field is uneven slightly, the density irregularity does not likely occur.

Further, as another reason (for causing the density irregularity), adhesion generated between toner and an image bearer is exemplified. This adhesion works in a direction to inhibit transfer operation of the toner onto the recording sheet. Accordingly, to transfer the toner onto the recording sheet, electrostatic force to be applied to the toner by an electric field needs to exceed the adhesion caused between the toner and the image bearer. However, due to existence of the correlation between the transfer rate and the adhesion, if the adhesion is controlled, the transfer rate can be effectively controlled. Further, since an image is degraded by increased toner adhesion, such a problem can be resolved by appropriately controlling the adhesion to be a prescribed value. Here, such degradation of the toner particles can be a cause to increase the adhesion. Further, the toner particles are generally charged when stirred and mixed with carrier particles in the developing device. However, when the toner particles are accumulated in the developing device and repeatedly mixed and stirred with the carrier particles, toner particles are deteriorated such that external additives are buried or the like, thereby increasing the adhesion as a result. Therefore, by executing toner ejection control of ejecting the toner stored in the developing device while replenishing fresh toner, the adhesion before the degradation occurs can be recovered. That is, by replacing the toner stored in the developer with fresh toner, the adhesion can be reduced. Hence, transfer operation can be preferably achieved even onto the relatively large sized sheet having the large surface roughness.

However, it is not effective to execute toner ejection control every time, because a great amount of toner is consumed. Then, as a countermeasure, after a surface roughness of the recording sheet is detected and it is determined that a transfer rate is less than a prescribed threshold based thereon, the toner ejection control is executed (for the first time). As a result, a fine image can be outputted on the recording sheet regardless of a type thereof.

Further, the toner adhesion is the sum of strength of electrostatic and non-electrostatic adhesions. However, among these adhesions, the non-electrostatic adhesion can be weakened by applying a lubricant to the image bearer. Further, by increasing a quantity of the lubricant applied to the image bearer, friction caused between the toner and the image bearer and accordingly the adhesion can be reduced. Consequently, preferable transfer operation can be achieved. Specifically, if the quantity of the lubricant increases, the lubricant can be uniformly applied to the image bearer, and accordingly the adhesion can be precisely decreased. However, when the lubricant is excessively supplied, a risk arises such that the charging roller dirties or the similar event occurs. Further, when a large quantity of the lubricant is frequently applied to the image bearer, the lubricant is quickly consumed increasing a cost thereof as a problem. Then, similar to the toner ejection control, the quantity of the lubricant is controlled to increase simply when it is determined by the transfer rate detector that the transfer rate is decreasing. As a result, a quality image can be outputted onto a recording sheet regardless of a type thereof reducing a cost.

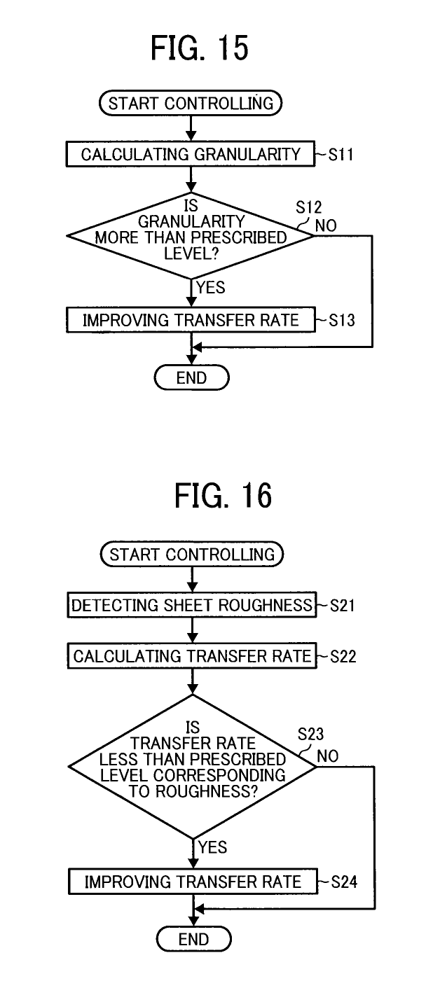

Now, a control sequence executed according to one embodiment of the present invention is described with reference to FIG. 15. When the solid image pattern is transferred onto the recording sheet P, the control unit 120 measures granularity of the toner image thereon using the image read sensor 121 in step S11. If the granularity exceeds a prescribed threshold (Yes, in step S12), both or one of the toner discharging control and the lubricant quantity control is executed to improve the transferal rate in step S13. As mentioned earlier, during the toner ejection control, although the electrostatic latent image is formed on the photo-conductor 2 and is render visible by the developing device 8, the toner image is removed therefrom omitting a toner transfer process and fresh toner is supplied to the second conveyance chamber of the developer conveyance section 13K provided in the developing unit 8 as shown in FIG. 3. Now, another control sequence executed according to the other embodiment of the present invention is described with reference to FIG. 16. In this embodiment, surface roughness of the recording sheet P and the transfer rate are detected by a surface characteristics detection device 95 in steps S21 and S22, respectively. Then, if the transfer rate is less than a prescribed value (Yes, in step S23), the above-described transfer rate improving process is executed in step S24.

Now, a comparison experiment executed by the applicant of the present invention is described with reference to the third Table. Here, a general configuration of an image forming apparatus employed in the comparison experiment as described herein below is substantially the same as the image forming apparatus as shown in FIG. 1. Further, each of various examples is executed under the below described common conditions using toner-C as toner. Specifically, a transfer bias is about −42 μA. A toner weight per unit area is the product of 4.2×10⁻³ kg/m². Further, in the comparison experiment, an image is formed by the above-described various embodiments by repeatedly outputting 10-recording sheets per unit time and evaluating the images at every one hundred recording sheets until one thousand recording sheets of the images are totally outputted. Further, the evaluation is executed as described herein below. First, multiple images having an image area rate of about 10% in a main scanning direction, which is a condition to likely degrade toner stored in the developer unit, are continuously outputted. Subsequently, the thus output images are evaluated based on the above-described granularity. Here, the images are outputted by alternatively using the recording sheets A and C at every one hundred recording sheets. Specifically, in the (practical) examples, the granularity of an outputted image is detected and compared at every one hundred recording sheets. Further, as shown in the third Table, according to the (practical) examples, a difference dmax in surface roughness and an averaged roughness Ra of the recording sheet obtained by the applicant from the experiments are classified into five sections while the number of rotations of the lubricant coating member 51 is changed to allocate a quantity of the lubricant to be applied in accordance with the section.

THIRD TABLE

| | | | | | |
|---|---|---|---|---|---|
| Dmax (μm) | 0.0 < 10.0 | 10.0 < 15.0 | 15.0 < 20.0 | 20.0 < 30.0 | 30.0< |
| Sa (μm) | 0.0 < 0.5 | 0.5 < 1.0 | 1.0 < 1.5 | 1.5 < 2.0 | 2.0< |
| Amount of Lubricant | 1 × 10⁴ | 1.5 × 10⁴ | 3 × 10⁴ | 6 × 10⁴ | 8 × 10⁴ |
| (mg/km²⁾ | | | | | |

Further, in the comparison experiment, the transfer rate control is not executed in a first comparative example. Whereas, in the first practical example, granularity of a first image is detected at every outputs and toner ejection control is executed when the thus detected granularity exceeds about 0.4. A quantity of lubricant is controlled in the second practical example. The maximum difference in roughness and a transfer rate of a recording sheet P are detected for a first image at every outputs and the toner ejection control is executed when the transfer rate thus detected is less than the first expression in the third practical example. A quantity of lubricant is changed in accordance with the difference in the roughness corresponding to third Table in the fourth practical example. A transfer rate and an averaged roughness Ra of a recording sheet P are measured and calculated and the toner ejection control is executed when the transfer rate thus measured is less than the second expression in the fifth practical example. A quantity of lubricant is changed in the sixth practical example.

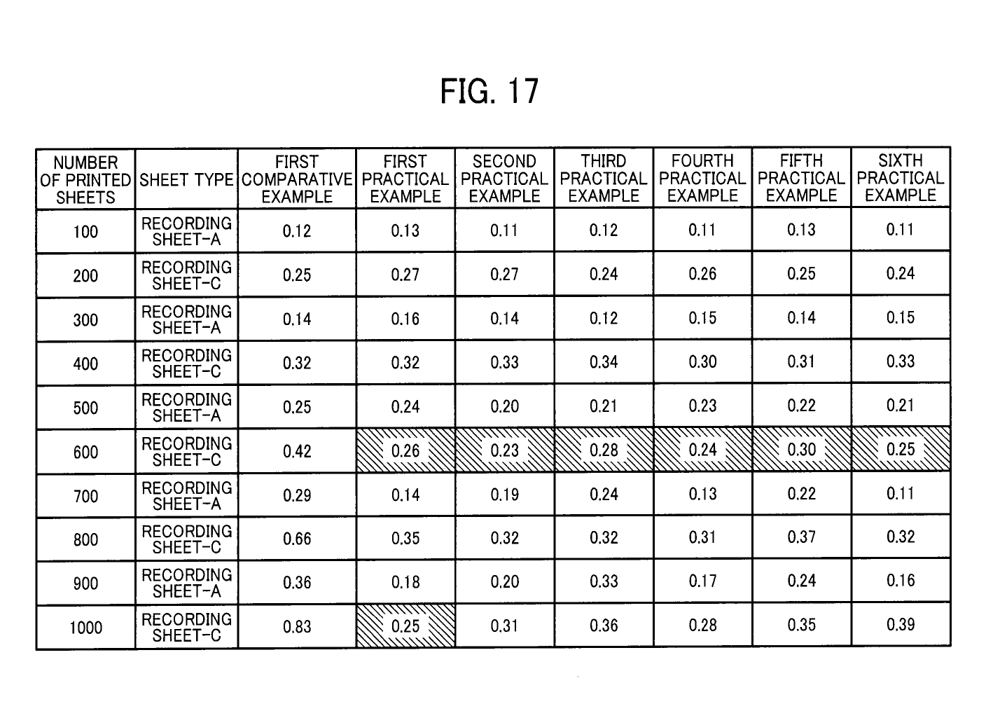

A result of granularity detection obtained at every one hundred recording sheets is shown in FIG. 17. As shown there, a shaded region represents that either the toner ejection control or the lubricant coating control is executed. Further, as shown there, the granularity increases and exceeds about 0.4 thereby generating the density irregularity when an image is printed on a recording sheet having the large surface roughness in the first comparative example. Whereas, it is understood from the first to sixth practical examples that a quality image can be constantly obtained without generating the density irregularity.

As described heretofore, according to one embodiment of the present invention, by controlling the granularity not affected by the surface characteristics of the recording sheet based on a preferable correlation between the granularity and the result of a subjective assessment executed close to an actual density irregularity, the density irregularity can be highly precisely reduced.

Further, since the granularity is controlled by controlling the transfer rate having the correlation with the granularity of the toner image transferred onto the recording medium, the density irregularity can be highly precisely reduced. That is, an image forming apparatus includes an image bearer to bear a latent image formed thereon, a developing device to render visible the latent image borne on the image bearer into a toner image, a transfer device to transfer the toner image from the image bearer onto a recording medium either directly or via an intermediate transfer member, a granularity detector to detect granularity of the toner image transferred onto the recording medium, an image detector to recognize image degradation when the granularity detected by the granularity detector exceeds a prescribed threshold, and a controller to control a transfer rate of toner in the toner image transferred onto the recording medium to reduce the image degradation. Further because, a toner adhering amount detector is provided to detect an amount of toner adhering to either the image bearer or the intermediate transfer member before and after the toner image is transferred onto the recording medium, so that the granularity detector can calculate the transfer rate of the toner transferred onto the recording medium based on the adhering amount of the toner detected by the toner adhering amount detector before and after the toner image is transferred thereonto as a transfer rate calculator. Further because, a surface characteristics detector is provided to detect a degree of surface roughness of the recording medium, so that the controller can control the transfer rate in accordance with the degree of the surface roughness detected by the surface characteristics detector. For example, the transfer rate controller controls the transfer rate to exceed a transfer rate η1 for a maximum difference dmax [m] in roughness detected by the surface characteristics detector, wherein η1=4.5×10⁵×dmax+86[%]. Otherwise, the transfer rate controller controls the transfer rate to exceed a transfer rate η2 for an averaged roughness Ra [m] detected by the surface characteristics detector and averaged thereafter, wherein η2=2.46×10⁶×Ra+88[%]. Further, the transfer rate controller controls the transfer rate by controlling adhesion of the toner onto one of the image bearer and the intermediate transfer member. Specifically, the transfer rate controller controls the adhesion of the toner by initially forming a toner image on the image bearer and then removing the toner image therefrom while supplying fresh toner into the developing device as a toner ejection control process. Further because, a lubricant coating device is provided to coat the surface of the image bearer with lubricant, so that the transfer rate processor can control the adhesion of the toner by changing a quantity of the lubricant coated onto the image bearer.

The above-described various embodiments simply represent typical examples, and it is similarly confirmed in the other various image formation devices under various image formation environments that even if a configuration or a processing condition is changed, an advantage to be obtained by one of the above-described various embodiments of the present invention can be obtained as well.

Further, although as the transfer rate control manner the toner ejection control and/or the lubricant coating amount control is described heretofore, it is not limited thereto and transfer current control can be employed to change a transfer current instead. Further, the above-described order of various control steps is not limited thereto, and can be appropriately changed.

Numerous additional modifications and variations of the present invention are possible in light of the above teachings. It is therefore to be understood that within the scope of the appended claims, the present invention may be executed otherwise than as specifically described herein.

What is claimed is:

1. An image forming apparatus, comprising:
an image bearer to bear a latent image formed thereon;
a developing device to render visible the latent image borne on the image bearer into a toner image;
a transfer device to transfer the toner image from the image bearer onto a recording medium either directly or via an intermediate transfer member;
a granularity detector to detect granularity of the toner image transferred onto the recording medium; and
a controller to control a transfer rate of toner in the toner image transferred onto the recording medium to reduce the image degradation when the granularity detected by the granularity detector exceeds a prescribed threshold.

2. The image forming apparatus as claimed in claim 1, further comprising:
a toner adhering amount detector to detect an amount of toner adhering to either the image bearer or the intermediate transfer member before and after the toner image is transferred onto the recording medium,
wherein the granularity detector calculates the transfer rate of the toner transferred onto the recording medium based on the adhering amount of the toner detected by the toner adhering amount detector before and after the toner image is transferred thereonto as a transfer rate calculator.

3. The image forming apparatus as claimed in claim 1, wherein the transfer rate controller controls the transfer rate by controlling adhesion of the toner onto one of the image bearer and the intermediate transfer member.

4. The image forming apparatus as claimed in claim 2, further comprising a surface characteristics detector to detect a degree of surface roughness of the recording medium, wherein the controller controls the transfer rate in accordance with the degree of the surface roughness detected by the surface characteristics detector.

5. The image forming apparatus as claimed in claim 3, wherein the transfer rate controller controls the adhesion of the toner by initially forming a toner image on the image bearer and then removing the toner image therefrom while supplying fresh toner into the developing device as a toner ejection control process.

6. The image forming apparatus as claimed in claim 3, further comprising a lubricant coating device to coat the surface of the image bearer with lubricant,
wherein the transfer rate processor controls the adhesion of the toner by changing a quantity of the lubricant coated onto the image bearer.

7. The image forming apparatus as claimed in claim 4, wherein the transfer rate controller controls the transfer rate to exceed a transfer rate η1 for a maximum difference dmax [m] in roughness detected by the surface characteristics detector,
wherein η1=4.5×10⁵×dmax+86[%].

8. The image forming apparatus as claimed in claim 4, wherein the transfer rate controller controls the transfer rate to exceed a transfer rate 112 for an averaged roughness Ra [m] detected by the surface characteristics detector and averaged thereafter,
wherein η2=2.46×10⁶×Ra+88[%].

9. A method of forming an image, comprising the steps of:
forming and bearing a latent image on an image bearer;
rendering visible the latent image borne on the image bearer into a toner image using a developing device;
transferring the toner image from the image bearer onto a recording medium either directly or via an intermediate transfer member using a transfer device;
detecting granularity of the toner image transferred onto the recording medium using a granularity detector; and
controlling a transfer rate of toner in the toner image transferred onto the recording medium to reduce the image degradation using a transfer rate controller when the detected granularity exceeds a prescribed threshold.

10. The method of forming an image as claimed in claim 9, further comprising the steps of
detecting an amount of toner adhering to either the image bearer or the intermediate transfer member before and after the toner image is transferred onto the recording medium using a toner adhering amount detector; and
calculating the transfer rate of the toner transferred onto the recording medium based on the adhering amount of the toner detected by the toner adhering amount detector before and after the toner image is transferred thereonto using the granularity detector serving as a transfer rate calculator.

11. The method of forming an image as claimed in claim 9, further comprising the steps of:
coating the surface of the image bearer with lubricant using a lubricant coating device; and
controlling the adhesion of the toner by changing a quantity of the lubricant coated onto the image bearer using the transfer rate processor.

12. The method of forming an image as claimed in claim 10, wherein the transfer rate controller controls the transfer rate by controlling adhesion of the toner onto one of the image bearer and the intermediate transfer member.

13. The method of forming an image as claimed in claim 11, wherein the transfer rate controller controls the transfer rate to exceed a transfer rate η1 for a maximum difference dmax [m] in roughness detected by the surface characteristics detector,
wherein η1=4.5×10⁵×dmax+86[%].

14. The method of forming an image as claimed in claim 11, wherein the transfer rate controller controls the transfer rate to exceed a transfer rate η2 for an averaged roughness Ra [m] detected by the surface characteristics detector and averaged thereafter,
wherein η2=2.46×10⁶×Ra+88[%].

15. The method of forming an image as claimed in claim 12, further comprising the steps of:
detecting a degree of surface roughness of the recording medium using a surface characteristics detector; and
controlling the transfer rate in accordance with the degree of the surface roughness detected by the surface characteristics detector using the transfer rate controller.

16. The method of forming an image as claimed in claim 12, wherein the transfer rate controller controls the adhesion of the toner by initially forming a toner image on the image bearer and then removing the toner image therefrom while supplying fresh toner into the developing device as a toner ejection control process.

17. An image forming apparatus, comprising:
means for forming and bearing a latent image on an image bearer;
means for rendering visible the latent image borne on the image bearer into a toner image;
means for transferring the toner image from the image bearer onto a recording medium either directly or via an intermediate transfer member;
means for detecting granularity of the toner image transferred onto the recording medium; and
means for controlling a transfer rate of toner in the toner image transferred onto the recording medium to reduce the image degradation when the granularity detected by the granularity detecting means exceeds a prescribed threshold.

18. The image forming apparatus as claimed in claim 17, further comprising:
means for detecting an amount of toner adhering to either the image bearer or the intermediate transfer member before and after the toner image is transferred onto the recording medium; and
means for calculating the transfer rate of the toner transferred onto the recording medium based on the adhering amount of the toner detected by the toner adhering amount detector before and after the toner image is transferred thereonto.

19. The image forming apparatus as claimed in claim 18, further comprising:
means for detecting a degree of surface roughness of the recording medium; and
means for controlling the transfer rate in accordance with the degree of the surface roughness detected by the surface characteristics detector.

20. The image forming apparatus as claimed in claim 19, wherein the controller controls the transfer rate to exceed either a transfer rate η1 for a maximum difference dmax [m] in roughness detected by the surface characteristics detector, or a transfer rate η2 for an averaged roughness Ra [m] detected by the surface characteristics detector and averaged thereafter,
wherein η1=4.5×10⁵×dmax+86[%], and η2=2.46×10⁶×Ra+88[%].
